(19) United States
(12) Patent Application Publication
(10) Pub. No.: US 2006/0064373 A1
(43) Pub. Date: Mar. 23, 2006

(54) Remote payment terminal

(76) Inventor: Christopher Lee Kelley, Oakland, CA (US)

Correspondence Address: Christopher Kelley, 719 Longridge Rd., Oakland, CA, 94610, US

(21) Appl. No.: 10/934,836

(22) Filed: Sep. 2, 2004

(51) Int. Cl. G06Q 40/00

(52) U.S. Cl. 705/39

(57) ABSTRACT

A lightweight remote payment terminal is disclosed with the capability of capturing a tip amount and a signature authorizing a credit card transaction. The remote payment terminal allows diners to complete restaurant credit card transactions with minimal involvement from restaurant staff. A remote payment system is also disclosed that incorporates multiple remote payment terminals and one or more transaction servers. The transaction servers configure individual remote payment terminals with billing information, and the remote payment terminals capture information about credit cards that may be used for payment. A method of paying for credit card transactions is disclosed in which the non-tip portion of a bill is communicated to a remote terminal from a transaction server and the remote terminal is used to capture a tip amount and an authorizing signature. The transaction server obtains authorization to charge a credit card supplied by a user of the remote payment terminal either after or while the remote payment terminal captures information relating to the credit card transaction, including the user's signature.

### CROSS-REFERENCE TO RELATED APPLICATIONS

No related applications.

### TECHNICAL FIELD OF THE INVENTION

The present invention relates to systems and devices for conducting credit card transactions.

### BACKGROUND OF THE INVENTION

Traditionally in restaurants or other dining establishments featuring table service, at the end of the meal, the restaurant personnel provide the diner with a bill containing a statement of the charges for the meal. The diner then provides payment, either in cash or by means of a credit card. If the diner wishes to use a credit card, the restaurant personnel must return to the table, to pick up the credit card and bill and bring these back to some central location in the restaurant where the charge on the card can be authorized. The restaurant personnel must then make another return trip to the table, this time with the diner's credit card and a printed credit card draft. A diner's use of a credit card as a means of payment, therefore, introduces significant overhead into the payment process. Restaurant personnel must make at least two additional trips to the table: once to pick up the diner's credit card and once to return the credit card and the credit card charge draft. Diners are inconvenienced because they are required to stay at the table longer than they might otherwise elect to do. This limits the number of patrons that a restaurant may serve at any one meal.

An additional drawback of this arrangement is that the final amount to be charged to the diner's credit card is established only after the restaurant personnel authorizes the transaction and returns the credit card to the customer. Commonly the diner may then add some additional amount to the bill as a gratuity or “tip” in recognition of the service provided by the restaurant personnel. As a consequence, restaurant personnel must review each sales draft in order to determine what amount is actually to be charged to this diner's credit card. This information must be collected, manually entered and converted into an electronic format by restaurant personnel before it can be transmitted to the appropriate credit card entity for payment.

Standard credit card terminals used in restaurants are too bulky to be readily transported to a diner's table. Furthermore, because they usually require a wired connection to a phone line or a computer network, they are not readily transportable.

What is needed is a lightweight remote payment terminal that will allow diners to carry out their own credit card transactions from their table.

### BRIEF SUMMARY OF THE INVENTION

The present invention provides a simple, low-cost method that allows dining customers to perform the mechanics of carrying out credit card transactions from their restaurant table. The invention provides a mechanism by which customers can add a gratuity or “tip” to their bill and authorize a charge to their credit card for the total amount of the bill and the gratuity. Embodiments of the present invention have the advantage that restaurant personnel need not make multiple trips to the table after customers have been presented with the bill. In addition, customers need not wait for restaurant personnel to return to the table after dropping off the bill in order for the diner to make payment. Because the payment transaction is carried out entirely by the diner, restaurant personnel are not required either to pre-authorize the transaction or to manually enter the complete amount of the transaction after a tip has been added. This can significantly reduce the amount of work required from restaurant personnel and the expense and difficulty of capturing payment transactions.

The present invention may be embodied in remote payment terminals that incorporate a magnetic card reader and graphical display for presenting information, including the amount of the bill, to a diner. Remote payment terminals embodying the invention may also include buttons, a keypad or a touch sensitive input device allowing the diner to identify the amount of a gratuity that is to be added to the bill. In an embodiment of the present invention, the diner may provide a signature authorizing the transaction through the use of a touch sensitive input device. The remote payment terminals embodying the invention communicate transaction and credit card information using a wireless network.

### BRIEF DESCRIPTION OF THE DRAWINGS

FIG. 1 shows a perspective view of a remote payment terminal for use in a wireless remote payment system in accordance with an embodiment of the invention.

FIG. 2 illustrates the components of a remote payment system that incorporates remote payment terminals in accordance with an embodiment of the invention and the connections between the components of this remote payment system.

FIG. 3 shows a block diagram of the primary active electrical elements of a remote payment system constructed in accordance with an embodiment of the invention.

FIG. 4 illustrates a method for communicating transaction information, credit card authorization and transaction authorization information between a credit card authorizing entity, a transaction server and a remote payment terminal, in accordance with the present invention.

### DETAILED DESCRIPTION OF EMBODIMENTS OF THE INVENTION

In the following detailed description, specific designs for a remote payment terminal and a remote payment system that incorporates one or more remote payment terminals are disclosed. The details of the design of the remote payment terminal and the remote payment system are set forth in order to provide a thorough understanding of the present invention. It will be evident, however, to one skilled in the art that there are alternative designs for the remote payment terminal and remote payment system. In addition, a specific method of communication between the elements of the remote payment system is disclosed. It will be evident to one skilled in the art that the particular steps in this communication process may be modified or rearranged, but still allow the purposes of the invented remote payment system to be achieved.

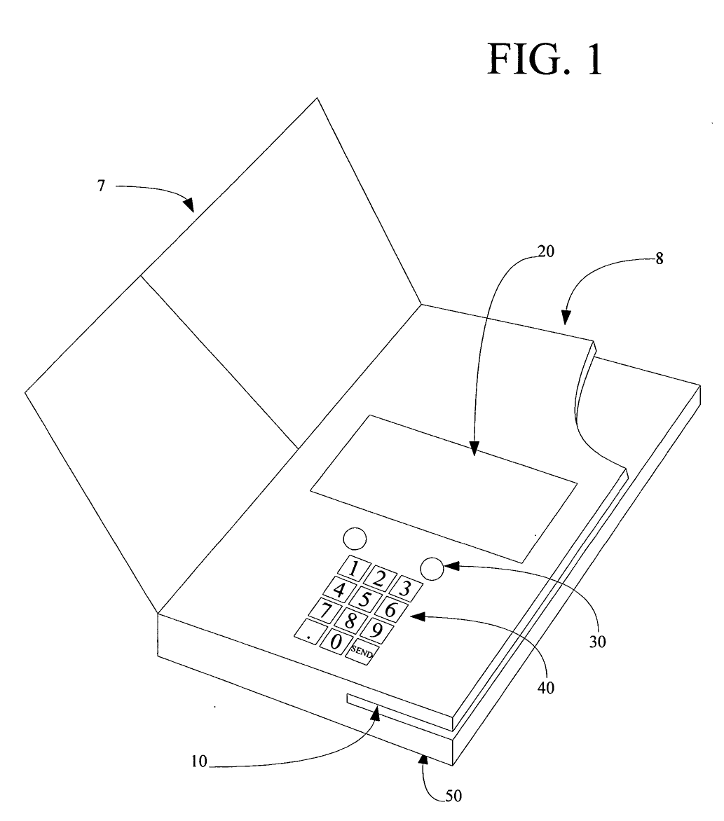

FIG. 1 illustrates one embodiment of the invented remote payment terminal. The remote payment terminal can be given the same approximate shape and size as guest check folders commonly used in restaurants. In the particular embodiment shown in FIG. 1, the remote payment terminal includes a front cover 7 and a back portion 8. The front cover 7 and the back portion 8 are connected and hinged along one side. The remote payment terminal can be closed, so that the front cover 7 rests on the top of the back portion 8, or it can be opened, in which case the top surface of the back portion 8 is revealed. Front cover 7 may include a pocket for holding paper records such as a printed bill.

The top surface of the back portion 8 may include a graphical display 20. The graphical display 20 can be used to display numerical amounts or textual data. Advantageously, the graphical display 20 can be constructed using a liquid crystal display (LCD). In addition, the graphical display 20 can be made touch-sensitive, so that it can be used with a stylus to allow a diner to form their signature on the graphical display. This allows the remote payment terminal to be used to capture a signature as part of the process in which a diner authorizes a charge to their credit card. If the graphical display 20 is touch-sensitive, a diner can also identify the amount of a tip for restaurant personnel that is to be added to the bill by drawing characters representing the amount of the tip on the touch-sensitive graphical display 20. The remote payment terminal can use optical character recognition (OCR) techniques in order to determine what numbers or characters have been drawn by the diner. In order to facilitate OCR processing, it may be desirable for the graphical display 20 to include pre-drawn lines that divide the display into a limited number of rectangular regions. Diners can then be instructed to form a single number of character in each of these regions, simplifying the character recognition problem for the OCR software.

The graphical display 20 may be used to display instruction to diners regarding what steps must be performed to use the remote payment terminal. In addition, the graphical display 20 may include regions on the display drawn to represent options or “buttons” that may be selected by the user by touching the graphical region corresponding to this option. The options may include such choices as canceling or completing the transaction.

The graphical display 20 may present the diner with the options either to identify a particular dollar amount as a tip or to set the tip amount as a percentage of the total bill. The graphical display 20 can then be used by the diner either to indicate the amount of the tip or the percentage of the bill that is to be provided as a tip. A graphical image of a keypad or a sequence of numbers “0” through “9,” can be drawn on graphical display 20. The user can then enter a number, digit by digit, by touching the portion of the graphical display 20 that corresponds to the “keys” on the graphical keypad or the appropriate region on graphical display 20 corresponding to a particular digit in a sequence of numbers “0” through “9.”

The remote payment terminal may also include one or more control buttons 30. The control buttons 30 can be located anywhere on the surface of the remote payment terminal, but are advantageously positioned below or to the side of the graphical display 20. The control buttons 30 can be used by the diner to navigate through options presented on the graphical display. For example, the control buttons 30 can be used to instruct the remote payment terminal to perform some action, such as proceeding with a credit card transaction, or they can be used by the diner to provide information about the transaction, such as a tip amount. The control buttons 30 may be dedicated to one particular selection, or they can be assigned dynamically to correspond to a particular selection made by the diner and the graphical display 20 may be used to identify selection has been assigned to each of the control buttons 30 at any particular time.

One possible use of control buttons 30 is in determining the amount of a tip to be added to the bill. The control buttons 30 might be used to indicate the amount of a tip to be added to the bill, with one button indicating that the amount of the tip should be increased, and another button indicating that it should be decreased. The current displayed tip amount could be displayed in graphical display 20. A third one of control buttons 30 might be used to indicate that the current tip amount was correct and that the remote payment terminal 5 should advance to the next step in the process of arranging credit card payment.

Another possible use of control buttons 30 is in signaling that the diner's credit card should be charged the amount of the bill and tip. When the diner has identified the amount of the tip, swiped their credit card and signed their name using display 20, they could authorize the completion of the credit card transaction using one of the control buttons 30.

The remote payment terminal may also include a keypad 40. The keypad 40 may include keys representing numbers to allow it to be used in entering the amount of a tip. In addition, the keypad 40 may include keys corresponding to particular functions to be performed by the remote payment terminal 5, thereby obviating the need for a separate set of control buttons 30. For example, in FIG. 1, one of the keys is shown labeled as “SEND.” A “SEND” key might be used by the diner to instruct the remote payment terminal to complete the credit card and billing process, using a signature and tip amount previously supplied by the diner.

The remote payment terminal also includes a magnetic strip reader 10, incorporated within a slot along one side of the terminal. Diners can use the magnetic strip reader 10 to “swipe” their credit cards. The magnetic strip reader 10 determines the credit card number from the magnetic strip, along with other identification and authentication information stored on the magnetic strips of standard credit cards.

An identifying machine-readable code 50 is affixed to the backside (not visible in FIG. 1) of the remote payment terminal 5. Machine-readable code 50 can take the form of a bar code or some other standardized code format such as a two-dimensional bar code. Examples of such codes include the PDF417 code or the UPS Maxicode™. The machine-readable code 50 is used to identify a particular remote payment terminal to the invented remote payment system as described herein.

The remote payment terminal is powered by an internal battery. Advantageously, this battery may be recharged without removing it from the remote payment terminal. An embodiment of the remote payment terminal that incorporates a battery that is rechargeable in place includes points of electrical contact for connecting the recharging circuitry for the internal battery with external charging circuitry. These points of electrical contact, which are not shown in FIG. 1, can be located anywhere on the remote payment terminal. They are most advantageously located on the bottom or the back of the remote payment terminal.

Other electronics required to implement the functions of the remote payment terminal and to control communications across a wireless network with server computers are located internal to the remote payment terminal. These electronics include a processor, memory, a wireless network interface and interfaces to magnetic strip reader 10, graphical display 20, control buttons 30 and keypad 40.

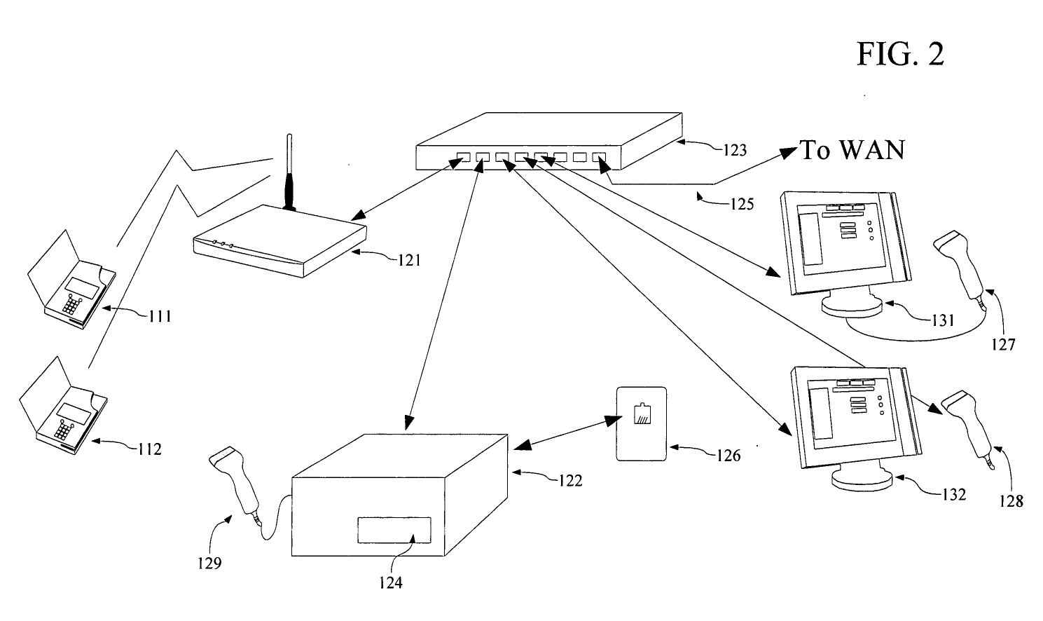

FIG. 2 illustrates one embodiment of a remote payment system in accordance with present invention. The system includes a wireless router 121, transaction server 122 and network switch 123. The wireless router 121 and transaction server 122 may be connected through network switch 123. Standard network protocols such as the IEEE 802 standards may be used to implement this network. If the facility in which the payment system is to be deployed is sufficiently large or if a significant number of remote payment terminals are deployed, additional wireless routers may be connected to network switch 123. Network switch 123 can connect to the various elements of the network using wired network connections, wireless network connections or some combination of both.

Transaction server 122 may communicate with a financial organization that processes credit card authorization requests, through a wide area network (WAN) connection 125 accessed through network switch 123. Alternatively, transaction server 122 may transmit credit card authorization requests using a telephone link 126, or using a WAN connection that connects directly to transaction server 122.

Advantageously, transaction server 122 may incorporate a RAID array 124 for reliably storing data regarding credit card transactions.

One of more Point of Sale (POS) terminals (131, 132) may be connected to network switch 123. If POS terminals (131, 132) are used in the system, it is desirable to locate a bar code reader (127, 128) with each POS terminal. Bar code readers may be connected directly as peripherals to individual POS terminals, as shown with bar code reader 127, or they can be separately networked through network switch 123, as shown with bar code reader 128. Bar code reader 127 may be connected to a POS terminal using a standard peripheral interface such as the Universal Serial Bus (USB) standard. Bar code reader 128 communicates with transaction server 122 through network switch 123. Bar code readers may also be connected directly to transaction server 122, as shown in FIG. 2 with bar code reader 129.

Multiple remote payment terminals may be deployed with this remote payment system. FIG. 2 illustrates two remote payment terminals, 111 and 112. Remote payments 111 and 112 communicate with transaction server 122 through wireless router 121 and network switch 123.

The remote payment system illustrated in FIG. 2 may be used to permit individual diners to perform bill settlement and to carry out credit card transactions from their tables. In accordance with the invented method of remote bill payment, restaurant personnel may present the printed receipt with a remote payment terminal (111, 112) to a diner at the completion of their meal. The diner can then use the remote payment terminal to complete the payment process from their table.

When POS terminals (131, 132) are deployed as part of the remote payment system, these POS terminals can be used by restaurant personnel to enter food orders and transmit them to the kitchen. When the bill is to be prepared, the POS terminal is used to determine the total amount of the diner's bill. The appropriate restaurant personnel may prepare and print an itemization of the bill. In addition, the restaurant staff member obtains physical possession of a remote payment terminal (111, 112) and uses a bar code reader (127, 128, 129) to read the identifying bar code from the back of the remote payment terminal (111, 112). Restaurant personnel then use the POS terminal (131, 132) to transmit a message to transaction server 122 requesting that the transaction server 122 initiate a payment transaction in the amount of the diner's bill, as identified by the POS terminal (131, 132), with the specific remote payment terminal (111, 112) identified by the bar code read by the bar code reader (127, 128, 129).

When transaction server 122 receives a request that it initiate a payment transaction, it configures the remote payment terminal (111, 112) with the information relating to the particular bill that is to be presented to the diner, including the amount of the bill. The restaurant staff member can then present the diner with the remote payment terminal (111, 112), which the diner can use to settle their bill with their credit card.

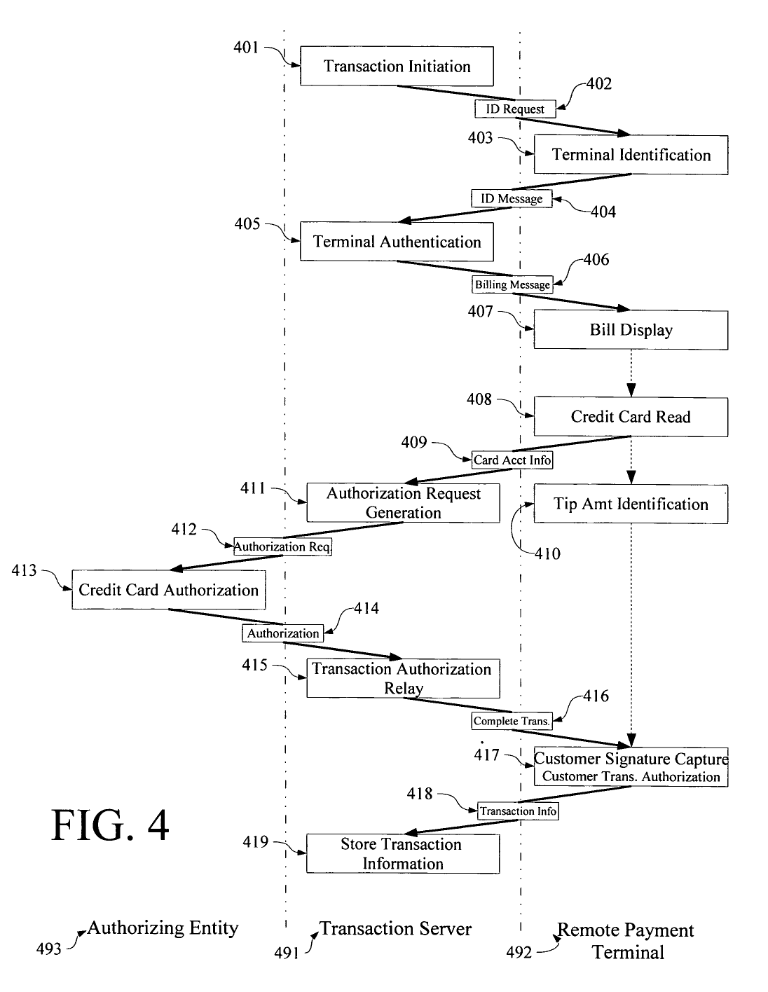

A particular method by which these steps may be performed is described in greater detail in connection with FIG. 4.

Some embodiments of the present invention may also incorporate a payment notification feature. When a diner at a table completes a payment transaction using a remote payment terminal (111, 112), transaction server 122 notifies the restaurant personnel that initiated the payment transaction, or other designated individuals, that payment has been made. Restaurant personnel may use this information to return to the table to assist diners with their departure. The information that payment has been completed may be displayed on POS terminals (131, 132) or restaurant personnel may be paged using the wireless network or telephone pagers.

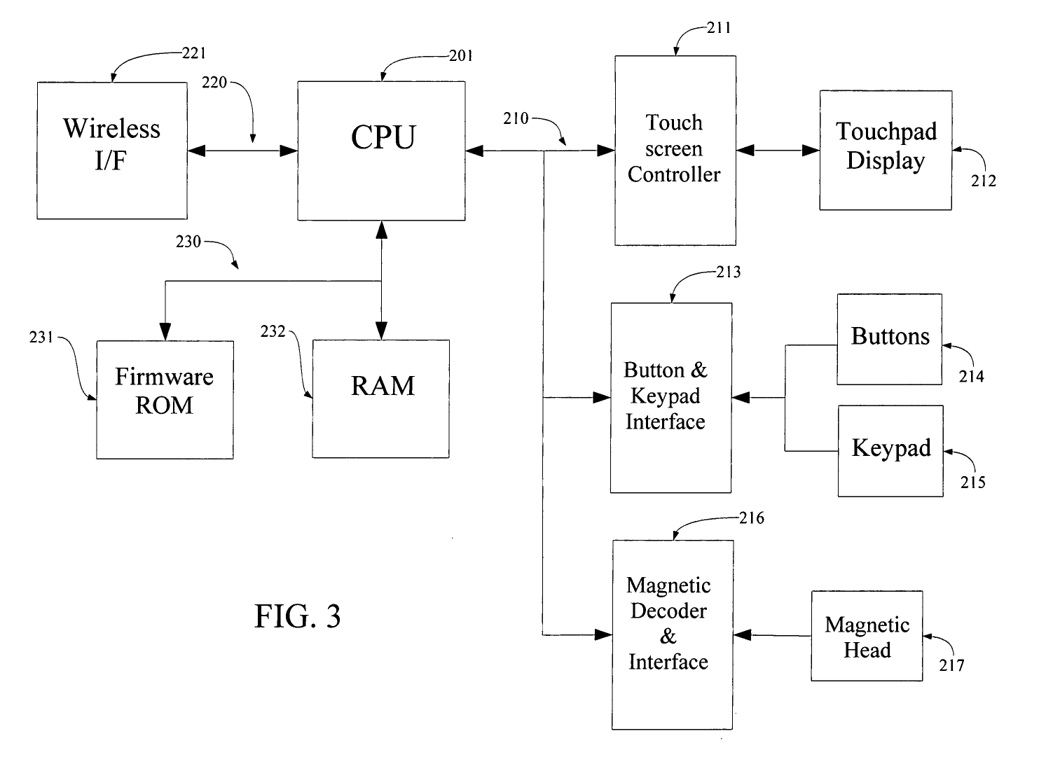

FIG. 3 illustrates the internal structure of an exemplary remote payment terminal constructed in accordance with the present invention. Processor 201 directs the operations of the remote payment terminal. Processor 201 includes interfaces to a standard input/output (I/O) bus 210, a network interface 220 and a memory interface 230. I/O bus 210 connects the various input/output devices accessible by the user of the remote payment terminal to processor 201. One input/output device that may be connected to the I/O bus is a touch-sensitive display 212, which can be used both to display information and instructions for the user, but can also be used to provide data input to the remote payment terminal. Touch-sensitive display 212 is connected to, and controlled by, touch screen controller 211, which is connected to I/O bus 210. Other devices that may be connected to I/O bus 210 include control buttons 214 and keypad 215. These devices are connected to interface circuitry 213 that detects when the control buttons 214 or keypad 215 have been depressed and stores information about which buttons or keys have been depressed. Touch screen controller 211 and interface circuitry 213 may have the capability of generating an interrupt for processor 201 when the user draws on touch-sensitive display 212 or depresses one of the controller buttons 214 or a key on keypad 215.

Magnetic decoder and interface logic 216 is also connected to I/O bus 210. A low-profile magnetic head 217 is connected to magnetic decoder and interface logic 216. The low-profile magnetic head 217 and magnetic decoder and interface logic 216 are used to read account and security information from the credit card provided by the diner.

Wireless network interface circuitry 221 is connected to network interface 220. The wireless network interface circuitry can receive and transmit wireless network traffic between the remote payment terminal and other system elements, such as a transaction server. Advantageously, a defined and widely deployed wireless network standard, such as one of the IEEE 802.11 standards, may be utilized to implement the wireless network.

Random access memory (RAM) 232 and firmware electrically erasable and programmable read only memory (EEPROM) 231 are connected to memory interface 230. Firmware EEPROM 231 is used to store operating code for the remote payment terminal and certain non-volatile data, including public and private key information and other security data fields. Advantageously, firmware EEPROM 231 may be reprogrammed. The new code for firmware EEPROM 231 may be transferred from a transaction server, such as that described connection with FIG. 2, to the wireless network interface 221 using the wireless network. The new code may be stored in RAM 232 as it is received by wireless network interface 221 and then, once fully assembled, used to reprogram firmware EEPROM 231.

The remote payment terminal is designed to run on a rechargeable battery, not shown in FIG. 3. Advantageously, the battery may be sufficiently large to allow the remote payment terminal to operate over the course of several hours without being recharged. The body of the remote payment terminal may be designed to include electrical contacts for connecting to a recharging device that will allow the battery to be recharged.

It may be advantageous to include circuitry for shutting down portions of the circuitry of the remote payment terminal circuitry during those periods when there is no billing transaction pending on the remote payment terminal. The operating code contained in firmware EEPROM 231 can cause processor 201 to place elements of the remote payment terminal circuitry, into energy-saving modes of operation. It may be possible to place processor 201 itself into a suspended state. In order to allow the remote payment terminal to be reawakened from the suspended state, the wireless network interface 221 may remain active to receive subsequent instructions from the transaction server and to awaken processor 201 to respond to these instructions.

FIG. 4 illustrates a protocol that may be used with an embodiment of the invented remote payment system. The protocol of FIG. 4 facilitates interactions between a transaction server 491, a remote payment terminal 492 and a credit card authorization entity 493. In the preferred embodiment, all communications between the transaction 491 and the remote payment terminal 492 are encrypted using a public key encryption system.

FIG. 4 is divided into three separate regions by two dashed lines that run vertically up through the Figure. Transaction steps that appear to the left of the leftmost line are performed by the credit card authorizing entity 493. Transaction steps that appear in the vertical region between the two dashed lines are performed by transaction server 491. Messages that are exchanged between either of the credit card authorizing entity 493 or the transaction server 491 are bisected by the leftmost dashed line. Transaction steps that appear in the vertical region to the right of the rightmost of the two dashed lines are performed by the remote payment terminal 492. Messages exchanged between either of the transaction server 491 or the remote payment terminal 492 are bisected by the rightmost dashed line.

During transaction initiation step 401, restaurant personnel may initiate a bill payment transaction. Restaurant personnel can do this by notifying the transaction server 491 that billing information is to be transmitted to a specific remote payment terminal 492. The amount of the bill to be paid can be entered manually at the transaction server 491 or transferred from a POS terminal. The restaurant personnel identify the remote payment terminal 492 that is to host the bill payment transaction by scanning the identifying code located on the back of the remote payment terminal 492. The identifying code, which may be a bar code, may be read using a bar code reader located at the transaction server 491 or at a POS terminal. If the identifying code is read using a bar code reader at a POS terminal, this bar code must be transmitted to the transaction server 491. The transaction server 491 looks up a table stored in its memory to determine the network address for the remote payment terminal having the particular identifying code that was read by the bar code reader. The transaction server then sends an ID Request message 402 to the remote payment terminal 492. The ID Request message contains a random ID request sequence and is encrypted.

During identification step 403, the remote payment terminal 492 combines the ID request sequence with a confidential secure ID code contained in the volatile memory of the remote payment terminal 492. The remote payment terminal 492 is designed so that if the electronic internals of the remote payment terminal 492 are opened or otherwise tampered with, the secure ID code will be lost. The combination of the secure ID code and the random ID request sequence from ID Request message 402 creates a response sequence. This is encrypted and transmitted in identification message 404 to the transaction server 491.

During terminal authentication step 405, the transaction server 491 decrypts the identification message 404 and determines if the response sequence contained in the identification message 404 has the value expected. If there is a match, the transaction server 491 assumes that the remote payment terminal 492 is secure and may be used in a payment transaction. The transaction server 491 generates a billing message 406 containing the amount of the bill. It may also contain other information such as an itemization of the bill, the name of the server, the table number and other information. The billing message is then transmitted to the remote payment terminal 492. If the response sequence contained in identification message 404 does not contain the value expected by the transaction server 491, the transaction server 491 identifies a problem with the remote payment terminal 492 to restaurant personnel using the system.

In bill display step 407, the remote payment terminal 492 causes the amount of the bill to be displayed on a graphical display, such as a LCD, incorporated within the remote payment terminal 492. At this point, restaurant personnel may deliver the remote payment terminal 492 to the appropriate table. Typically, a paper receipt would also be carried to the table with the remote payment terminal 492. This receipt is for the use of the diner and can be taken with them when they leave the restaurant.

In credit card read step 408, the diner swipes their credit card through a magnetic card reader in the remote payment terminal 492. The remote payment terminal 492 then generates a credit card identification message 409, which is transmitted to transaction server 491. The card account information message 409, which is encrypted using the public key of the transaction server 491, contains the credit card number and other authentication information read from the magnetic strip on the credit card.

In tip identification step 410, the diner uses the remote payment terminal 492 to enter the amount of a tip, if any, to be added to the bill. Advantageously, the remote payment terminal 492 can be programmed to display the total amount of the bill with the tip added after the diner has entered a tip amount.

Steps 411, 413 and 415 may proceed, and messages 412, 414 and 416 may be sent, simultaneously with tip identification step 410. In authorization request generation step 411, the transaction server 491 decrypts the card account information message 409 received from the remote payment terminal 492 and generates an authorization request 412. The authorization request 412 contains information identifying the credit card is to be charged and the amount of charge. This amount may reflect the bill amount contained in billing message 406 or it may also include some allowance for an anticipated tip, although the actual amount of the tip may not yet be known. Authorization request 412 is then sent, using a communication channel such as a wide area network connection or a telephone line, to credit card authorizing entity 493. In credit card authorization step 413, the credit card authorizing agency determines whether to authorize or decline the requested charge. If the proposed credit card charge is authorized, the credit card authorizing entity generates an authorization message 414 that is sent to transaction server 491.

In transaction authorization relay step 415, if the credit card authorizing entity 493 has authorized the transaction, the transaction server 491 generates a complete transaction message 416, which is sent to remote payment terminal 492. The complete transaction message 416 indicates that the credit card transaction has been authorized and that the remote payment terminal may permit the diner to conclude the payment transaction.

If the credit card authorizing entity 493 declines the proposed transaction, transaction server 491 sends a terminate transaction message to the remote payment terminal 492. If the remote payment terminal 492 receives a terminate transaction message it indicates on its graphical display that there is a problem with the transaction and that payment will have to be made using an alternative method. In addition, transaction server 491 may notify the restaurant staff assigned to the diner's table that there is a problem with the transaction. This can be done through a graphical display, such as on a POS terminal. Alternatively, the transaction server 491 can send a paging message directed to the appropriate restaurant personnel to alert them to the card authorization difficulty.

Once the remote payment terminal 492 has received a complete transaction message 416, and tip identification step 410 has been completed, the remote payment terminal 492 may perform customer signature capture and customer transaction authorization step 417. In customer signature capture and customer transaction authorization step 417, the diner is asked to sign to authorize the transaction. In order to do this the diner can use a touch sensitive data capture device, such as a LCD, within the remote payment terminal 492. When the diner has formed their signature, the remote payment terminal 492 asks for authorization to charge the diner's credit card. The diner's consent to the transaction can be indicated either by pressing a button on remote payment terminal 492 or making appropriate notation on the touch sensitive data capture device on remote payment terminal 492.

When the diner has authorized the transaction, the remote payment terminal 492 constructs a transaction information message 418 that is transmitted to the transaction server 491. This message contains the amount of the tip selected by the diner as well as a captured image of the diner's signature.

When the transaction completion message 418 is received by transaction server 491, transaction server 491 conducts store transaction information step 419 in which information relating to the transaction is stored on a RAID array located within the transaction server 491. The transaction server 491 may retrieve this information later when the billing transaction is submitted to the credit card company for payment. Transactions may be submitted to the credit card company individually or they may be aggregated so that multiple transactions can be transmitted simultaneously.

If desired, transaction server 491 may communicate the fact that a payment transaction has been completed by paging the appropriate restaurant personnel. Paging may be done using a WAN connection or a telephone network connection to the transaction server 491.

In the preceding detailed description, the invention is described with reference to specific embodiments. It will, however, be evident that various modifications and changes to this invention can be made without departing from the scope of the invention as set forth in the claims. The specification and drawings are, accordingly, to be regarded in an illustrative rather than a restrictive sense.

What is claimed is:

1. A remote payment terminal for use in carrying out credit card transactions, comprising:
a processing unit;
a credit card reading unit for automatically reading account information from a credit card, coupled to said processing unit;
a wireless interface, coupled to said processing unit, for accessing a wireless network for receiving data identifying the bill amount to be paid and for transmitting information about a credit card transaction;
a display, coupled to said processing unit, for displaying the amount of the bill and the amount of the transaction to be charged to the credit card; and
a data entry device, coupled to said processing unit, that can be used to enter a tip amount and to form a signature.

2. The remote payment terminal of claim 1, wherein said credit card reading unit is a magnetic strip reader.

3. The remote payment terminal of claim 1, wherein said display is a touch-sensitive device such that said display and said data entry device can formed in the same physical device.

4. The remote payment terminal of claim 2, wherein said remote payment terminal further comprises:
a restaurant check folder having a receptacle for holding a printed billing statement, where said processing unit is located internal to said restaurant check folder and said display and said data entry pad are accessible from one surface of the restaurant check folder.

5. A method for arranging payment of restaurant bills using a credit card, comprising the steps of:
communicating a dining bill amount to a transaction server computer;
identifying a remote payment terminal to a transaction server computer by reference to a unique identification code associated with the remote payment terminal;
communicating said dining bill amount from said transaction server computer to said remote payment terminal using a wireless network protocol;
configuring said remote payment terminal to display the dining bill amount;
providing said remote payment terminal to a diner;
identifying a credit card account using a magnetic strip reader;
identifying a tip amount using said remote payment terminal;
forming a signature authorizing a credit card charge using said remote payment terminal; and
transferring either of said tip amount or the total amount of the transaction from said remote payment terminal to said transaction server computer.

6. The method for arranging payment of restaurant bills using a credit card of claim 5, further comprising the step of storing information regarding a credit card transaction, including the total amount of the bill with tip, on a hard disk array.

7. The method for arranging payment of restaurant bills using a credit card of claim 5, further comprising the steps of:
communicating said credit card account information from said remote payment terminal to said transaction server computer;
obtaining authorization to charge said dining bill amount to said credit card account;
communicating from said transaction server computer to said remote payment terminal the fact that said authorization has been obtained; and
indicating at said remote payment terminal that the credit card transaction is complete only after said remote payment terminal has received communication of the fact that said authorization has been obtained.
